(19) United States
(12) Patent Application Publication
(10) Pub. No.: US 2022/0167550 A1
(43) Pub. Date: Jun. 2, 2022

(54) Pull Behind Orchard Fertilizing Device

(71) Applicant: Mario Madriz, Atwater, CA (US)

(72) Inventor: Mario Madriz, Atwater, CA (US)

(21) Appl. No.: 17/107,519

(22) Filed: Nov. 30, 2020

(51) Int. Cl. A01C 19/04; A01C 15/00; A01C 15/18; F16H 19/04

(52) U.S. Cl. CPC A01C 19/04; F16H 19/04; A01C 15/18; A01C 15/007

(57) ABSTRACT

A pull behind orchard fertilizing device includes a hopper, a main frame, a wheel assembly, a material discharging assembly, a gear box, and a spreader. The hopper is mounted onto the main frame. The wheel assembly is rotatably mounted to the main frame. The material discharging assembly is integrated into the hopper so that the fertilizer that is stored within the hopper can be discharged into the spreader. The spreader is terminally mounted to the main frame and positioned below the hopper. The gear box is mounted to the main frame so that the wheel assembly can be operatively coupled with the material discharging assembly and the spreader through the main gear box, wherein discharged fertilizer from the hopper is dropped into the orchard field through the operation the spreader.

### FIELD OF THE INVENTION

The present invention relates generally to industrial fertilizing devices. More specifically, the present invention is a pull behind orchard fertilizing device that allows the users easily control the discharging amount of fertilizer and efficiently and linearly drop the fertilizer onto the orchard field.

### BACKGROUND OF THE INVENTION

Agricultural tow behind fertilizing devices are generally broadcast seeders that mount to the three-point hitch of an agricultural tractor, truck, or any other farm vehicles. The broadcast seeders that are mounted to the three-point hitch are generally powered by a power take-off (PTO) shaft from the agricultural tractor. The basic operating concept of broadcast spreads is simple. A large material hopper that stores fertilizer is positioned over at least one horizontal spinning disk which throws or drops fertilizer from the hopper out and away from the seeder/spreader. Alternately a pendulum spreading mechanism may be employed commercial spreaders for improved consistency in spreading. One of the main problem with the existing agricultural tow behind fertilizing devices is the controlling the amount of discharging fertilizer. Usually, this process is not available within the agricultural tow behind fertilizing devices or time consuming to adjust if available. Another problem with the agricultural tow behind fertilizing devices is that the discharged fertilizer is usually thrown or dropped all over the orchard field due to the configuration of the existing agricultural tow behind fertilizing devices thus wasting fertilizer and money.

It is therefore an objective of the present invention to provide an apparatus that allows the users easily control the discharging amount of fertilizer and efficiently and linearly drop the fertilizer onto the orchard field. More specifically, the fertilizer is discharged from the hopper via an auger, and the user can easily control the amount of fertilizer through a novel material discharging assembly. Furthermore, discharged material form the hopper is dropped into oppositely rotating conveyor belts of a spreader so that the fertilizer can be precisely placed or dropped onto the orchard field. Furthermore, the present invention does not require any PTO to operates and simply powered through the kinetic energy as the present invention is pulled through an agricultural tractor, truck, or any other types of farm vehicles.

### BRIEF DESCRIPTION OF THE DRAWINGS

FIG. 1 is a rear perspective view of the present invention.

FIG. 2 is a rear view of the present invention without the spreader.

FIG. 3 is a top perspective view of the present invention, showing the inside of the hopper.

FIG. 4 is another perspective view of the present invention, showing the inside of the hopper.

FIG. 5 is a front perspective view of the present invention, showing the front rack gear, the front pinion gear, and the handle.

FIG. 6 is a rear perspective view of the present invention, showing the rear rack gear and the rear pinion gear.

FIG. 7 is a rear view of the present invention, showing the rear opening of the material discharging assembly.

FIG. 8 is a rear view of the present invention, showing the left and right quick-connect output adaptor of the gear box.

FIG. 9 is a side view of the present invention, showing the gear box.

FIG. 10 is a front perspective view of the present invention, showing the clutch handle and the cable of the clutch system.

FIG. 11 is a front perspective view of the present invention, showing the left and right quick-connect input adaptor of the spreader.

### DETAIL DESCRIPTIONS OF THE INVENTION

All illustrations of the drawings are for the purpose of describing selected versions of the present invention and are not intended to limit the scope of the present invention.

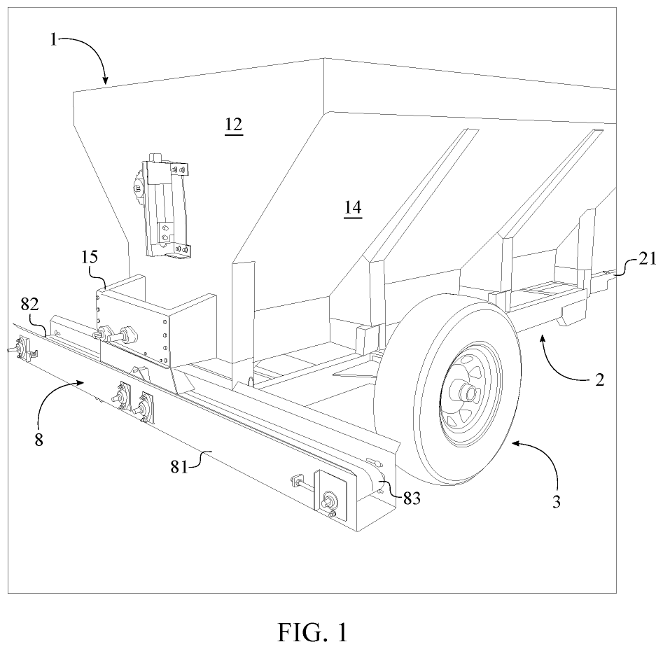

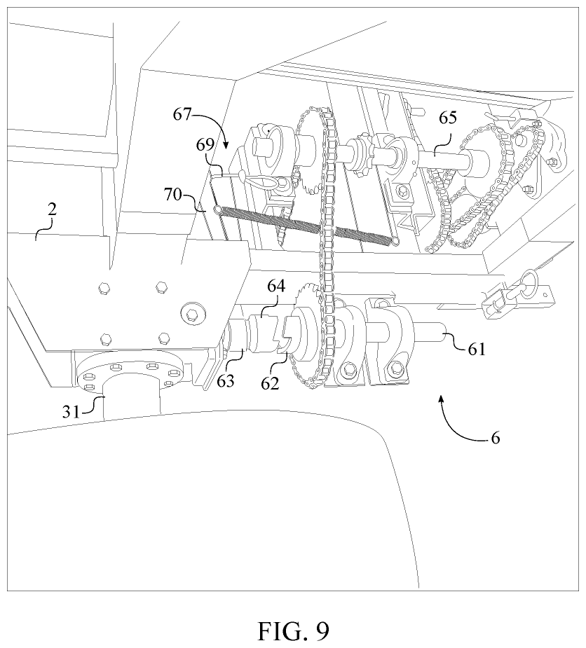

The present invention is a pull behind orchard fertilizing device that allows the users easily control the amount of fertilizer being discharged and linearly drops the fertilizer onto the orchard field. The present invention can be pulled with a tractor, truck, or any other types of farm vehicle and powered through the kinetic movement of aforementioned farm vehicle without requiring any other type of power source to operate. The present invention comprises a hopper 1, a main frame 2, a wheel assembly 3, a material discharging assembly 4, a gear box 6, and a spreader 8 as shown in FIG. 1 and FIG. 9.

In reference to the general configuration of the present invention, the hopper 1 that stores a quantity of fertilizer is mounted onto the main frame 2. The wheel assembly 3 is rotatably mounted to the main frame 2 so that the present invention can be easily moved along the orchard field. The material discharging assembly 4 is integrated into the hopper 1 and controls the amount the fertilizer that is discharged from the hopper 1. Furthermore, the material discharging assembly 4 is conveniently configured about the hopper 1 thus allowing the user of the present invention to easily operate the material discharging assembly 4. The spreader 8 is terminally mounted to the main frame 2 in such a way that the hopper 1 is positioned atop the spreader 8. When a consistent amount of fertilizer is discharged through the material discharging assembly 4, the spreader 8 is able to efficiently drop or release the corresponding amount of fertilizer into the orchard field. The gear box 6 is mounted to the main frame 2 so that the gear box 6 can harvest the kinetic energy of the wheel assembly 3 to operates the material discharging assembly 4 and the spreader 8. In other words, the wheel assembly 3 is operatively coupled with the material discharging assembly 4 and the spreader 8 through the main gear box 6 so that the quantity of fertilizer stored within the hopper 1 can be discharged through the operation of the material discharging assembly 4 and the spreader 8.

In reference to FIG. 1-3, the hopper 1 is generally a V-shaped reservoir that is opened from the top end. The opening allows a loader to easily fill up the hopper 1 with the amount of fertilizer until the hopper 1 reaches its maximum capacity. Furthermore, the V-shaped configuration enables the gravity to pull the amount of fertilizer into a bottom end of the hopper 1 thus minimizing the fertilizer wastage.

In reference to FIG. 1, the main frame 2 is the primary structural body of the present invention as the rest of the components of the present invention is configured about the main frame 2. Since the hopper 1 is mounted onto the main frame 2, the main frame 2 structurally is reinforced so that the main frame 2 can withstand the total weight of the hopper 1 and the quantity of fertilizer. A tractor mount 21 of the present invention is terminally connected to the main frame 2 so that the tractor mount 21 can be utilized to attach the present invention onto a tractor, truck, or any other types of farm vehicle. The tractor mount 21 and the spreader 8 are oppositely positioned of each other about the main frame 2. As a result, the tractor mount 21 and the spreader 8 are able to independently operate from each other without having to interfere with each other.

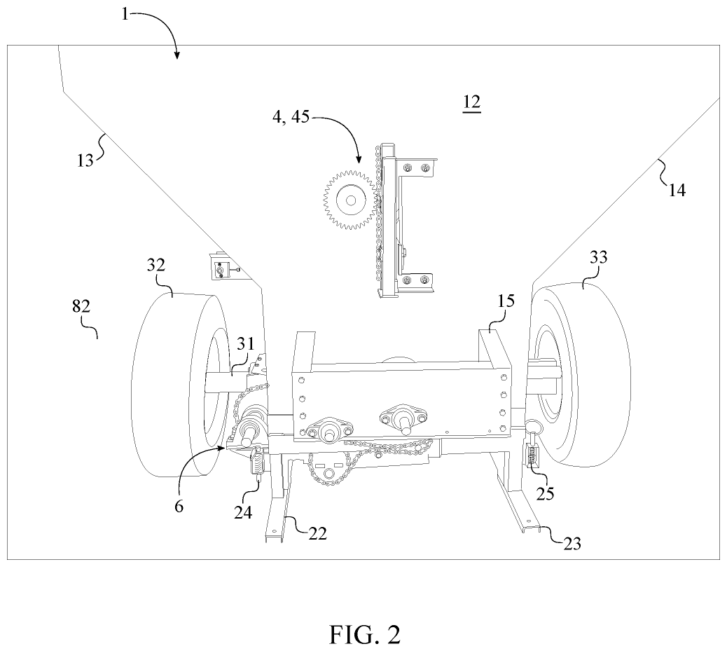

In reference to FIG. 1-2, the present invention further comprises a splash guard 15. The splash guard 15 functions as a barrier for the amount the fertilizer that is discharged from the hopper 1. The splash guard 15 is terminally connected to a rear wall 12 of the hopper 1 and positioned atop the spreader 8. As a result, when the amount of fertilizer is discharged from the hopper 1 via the material discharging assembly 4, the splash guard 15 is able to redirect the amount of fertilizer into the spreader 8 without any wastage.

In reference to FIG. 2, the wheel assembly 3 that allows the present invention to move along with a pulling vehicle comprises a straight axle 31, a left wheel 32, and a right wheel 33. The straight axle 31 is rotatably mounted to the main frame 2 so that the left wheel 32 and the right wheel 33 can simultaneously rotated. The left wheel 32 is terminally mounted to the straight axle 31, wherein the left wheel 32 is positioned adjacent to a left sidewall 13 of the hopper 1. The right wheel 33 is terminally mounted to the straight axle 31, wherein the right wheel 33 is positioned adjacent to a right sidewall 14 of the hopper 1. Furthermore, the left wheel 32 and the right wheel 33 are outwardly positioned to the main frame 2 in order to provide the maximum about of the stability to the present invention. Even though the present invention is preferably utilized a single wheel assembly 3, the present invention can use a plurality of wheel assemblies to accommodate the total load capacity, structural dimensions, terrain of the orchard field, or any other requirements.

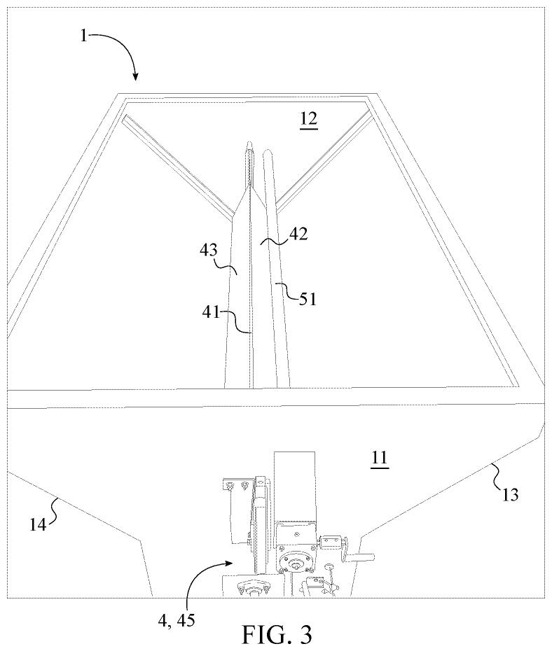

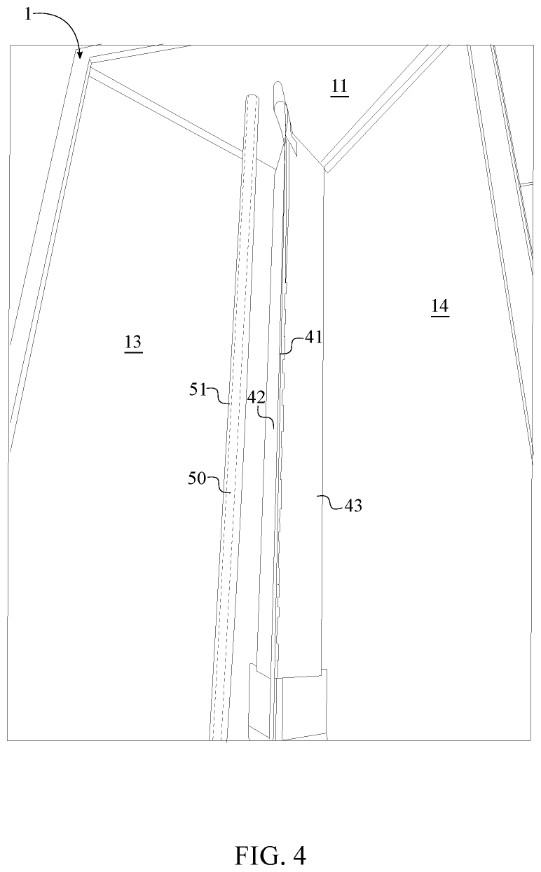

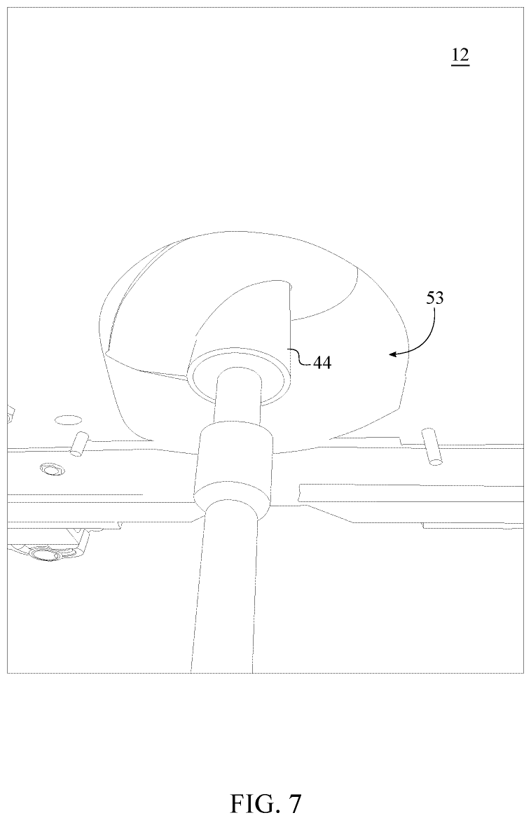

In reference to FIG. 3-4 and FIG. 7, the material discharging assembly 4 comprises a main support 41, a first panel 42, a second panel 43, an auger 44, a gear assembly 45, and a rear opening 53. The main support 41, the first panel 42, the second panel 43, and the auger 44 are positioned within the hopper 1 and pushes out the fertilizer. Then, the fertilizer is able to exit the hopper 1 through the rear opening 53. The gear assembly 45 allows the user to control the amount of fertilizer pushed through the rear opening 53. More specifically, the main support 41 is internally positioned within the hopper 1 and linearly extended from a front wall 11 of the hopper 1 to the rear wall 12 of the hopper 1. The main support 41 allows the first panel 42 and the second panel 43 to operationally connected within the hopper 1. The first panel 42 and the second panel 43 are oppositely positioned of each other about the main support 41 and function as adjustable dampers for the auger 44. The first panel 42 is hingedly connected to the main support 41 and extended along the hopper 1. The second panel 43 is hingedly connected to the main support 41 and extended along the hopper 1. The auger 44 is rotatably mounted within the hopper 1 and positioned within the first panel 42 and the second panel 43 so that the fertilizer can be pushed out of the hopper 1. The rear opening 53 traverses through the rear wall 12 of the hopper 1 so that the auger 44 can be extended through the rear opening 53 and into the splash guard 15 thus allowing the fertilizer to exit the hopper 1. The main support 41 is operatively coupled with the gear assembly 45, wherein the gear assembly 45 raises and lowers the main support 41 which simultaneously raises and lowers the first panel 42 and the second panel 43 to control the amount of the fertilizer.

More specifically, a left angular panel and a right angular panel of the material discharging assembly 4 are terminally connected to each other about a top edge of the left angular panel and the right angular panel. A bottom edge of the left angular panel is internally connected to the left sidewall 13 of the hopper 1. A bottom edge of the right angular panel is internally connected to the right sidewall 14 of the hopper 1. Resultantly, the left angular panel and the right angular panel are able to create an upside down V-shape structure with respect to the hopper 1. Due to the configuration of the left angular panel and the right angular panel, the first panel 42 and the second panel 43 are able to maintain their angular shape and not collapse within the hopper 1. In other words, a top edge of the first panel 42 is hingedly connected with the main support 41 as a bottom edge of the first panel 42 rest upon the left angular panel. Similarly, a top edge of the second panel 43 is hingedly connected with the main support 41 as a bottom edge of the second panel 43 rest upon the right angular panel. Due to the hinged connection of the first panel 42 and the second panel 43, the angle between the first panel 42 and the second panel 43 can be adjusted by the user via the gear assembly 45. For example, when the main support 41 vertically moves upward due to the operation of the gear assembly 45, the gap between the first panel 42 and the left sidewall 13 of the hopper 1 and the gap between the second panel 43 and the right sidewall 14 of the hopper 1 increases. Then, the amount of the fertilizer discharged from the hopper 1 can be increased. When the main support 41 vertically moves downward due to the operation of the gear assembly 45, the gap between the first panel 42 and the left sidewall 13 of the hopper 1 and the gap between the second panel 43 and the right sidewall 14 of the hopper 1 decreases. Then, the amount of the fertilizer discharged from the hopper 1 can be decreased.

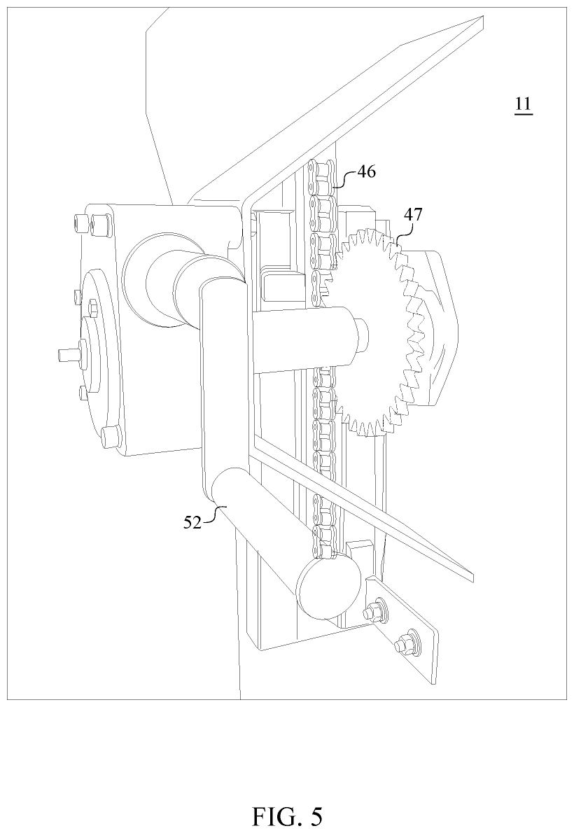

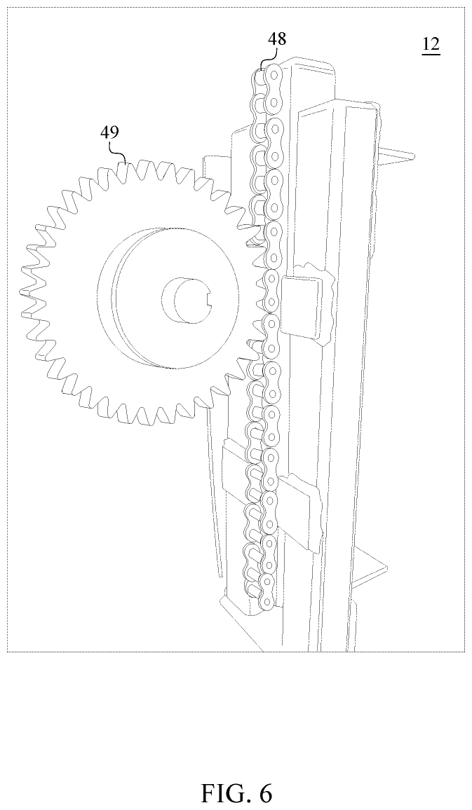

In reference to FIG. 5-6, the gear assembly 45 comprises a front rack gear 46, a front pinion gear 47, a rear rack gear 48, a rear pinion gear 49, a connector shaft 50, a tubular body 51, and a handle 52. More specifically, the tubular body 51 is connected to the front wall 11 of the hopper 1 and the rear wall 12 of the hopper 1. As result, the tubular body 51 is able to create an internal sealed-bridge between the front wall 11 of the hopper 1 and the rear wall 12 of the hopper 1. The connector shaft 50 is rotatably positioned within the tubular body 51 and is able to freely rotate as the tubular body 51 keeps away the fertilizer from the connector shaft 50. The front rack gear 46 is terminally connected to the main support 41 and positioned outside of the hopper 1. The front pinion gear 47 is rotatably connected to the front wall 11 of the hopper 1 so that the front pinion gear 47 can be rotatably engaged with the front rack gear 46. The rear rack gear 48 is terminally connected to the main support 41 and positioned outside of the hopper 1. The rear pinion gear 49 is rotatably connected to the rear wall 12 of the hopper 1 so that the rear pinion gear 49 can be rotatably engaged with the rear rack gear 48. The connector shaft 50 is terminally connected to the front pinion gear 47 and the rear pinion gear 49 thus transferring the rotation of front pinion gear 47 to the rear pinion gear 49. The handle 52 is connected onto the front pinion gear 47 so that the user can operates the gear assembly 45 via the rotational force of the handle 52.

For example, when the handle 52 is turned in clockwise direction, the front pinion gear 47 also turns in the clockwise direction. Then, the rear pinion gear 49 is simultaneously turned in the clockwise direction due to the connector shaft 50. As a result, the front rack gear 46 and the rear rack gear 48 move upward thus vertically lifting the main support 41. When the handle 52 is turned in counter-clockwise direction, the front pinion gear 47 also turns in the counter-clockwise direction. Then, the rear pinion gear 49 is simultaneously turned in the counter-clockwise direction due to the connector shaft 50. As a result, the front rack gear 46 and the rear rack gear 48 move downward thus vertically lowering the main support 41.

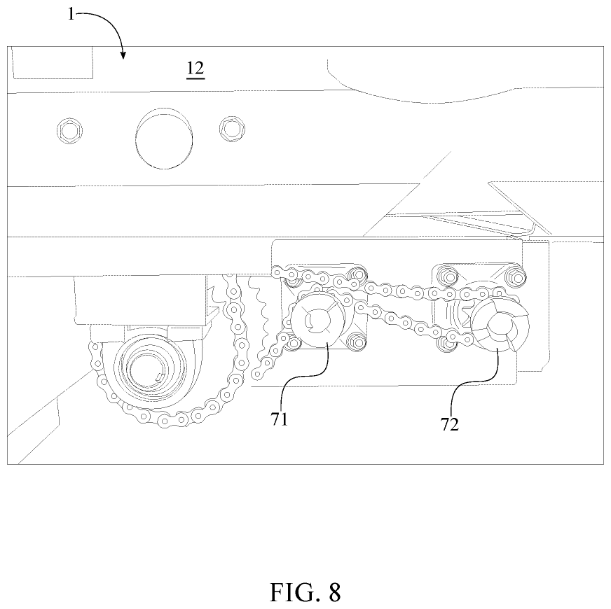

In reference to FIG. 8-9, the gear box 6 comprises a main shaft 61, a main ratchet gear 62, a wheel output shaft 63, a spring-loaded ratchet gear 64, a first distribution shaft 65, a clutch system 67, a left quick-connect output adaptor 71, and a right quick-connect output adaptor 72. The main shaft 61 and the first distribution shaft 65 are rotatably connected to the main frame 2 as the main ratchet gear 62 is terminally connected to the main shaft 61. The wheel output shaft 63 is rotatably connected to the straight axle 31 of the wheel assembly 3 so that the rotational energy of the straight axle 31 can be transferred into rotational energy of the wheel output shaft 63. The spring-loaded ratchet gear 64 is terminally connected to the wheel output shaft 63 so that the rotational energy of the wheel output shaft 63 can be selectively transferred into rotational energy of the main ratchet gear 62 and the main shaft 61. In other words, the main ratchet gear 62 and the spring-loaded ratchet gear 64 are selectively engaged with the clutch system 67 so that the clutch system 67 can engage and disengage the spring-loaded ratchet gear 64 from the main ratchet gear 62 upon the discretion of the user. When the clutch system 67 is at an engaged position, the wheel output shaft 63 is able to transfer the rotational energy into the main shaft 61 due to the interlocking engagement of the spring-loaded ratchet gear 64 and the main ratchet gear 62. When the clutch system 67 is at a disengaged position, the wheel output shaft 63 is not able to transfer the rotational energy to the main shaft 61 due to the offset positioning of the spring-loaded ratchet gear 64 and the main ratchet gear 62. The left quick-connect output adaptor 71 and the right quick-connect output adaptor 72 are rotatably connected to the main frame 2 and functions as the power transferring hubs to the spreader 8. The left quick-connect output adaptor 71 and the right quick-connect output adaptor 72 are operatively coupled with the first distribution shaft 65 so that the first distribution shaft 65 can rotate the left quick-connect output adaptor 71 and the right quick-connect output adaptor 72. The auger 44 is operatively coupled with the first distribution shaft 65 so that the first distribution shaft 65 can rotate the auger 44. The main shaft 61 is operatively coupled with the first distribution shaft 65, wherein the main shaft 61 rotates the first distribution shaft 65. In other words, the rotational energy of the main shaft 61 can be transferred to the rotational energy of the first distribution shaft 65.

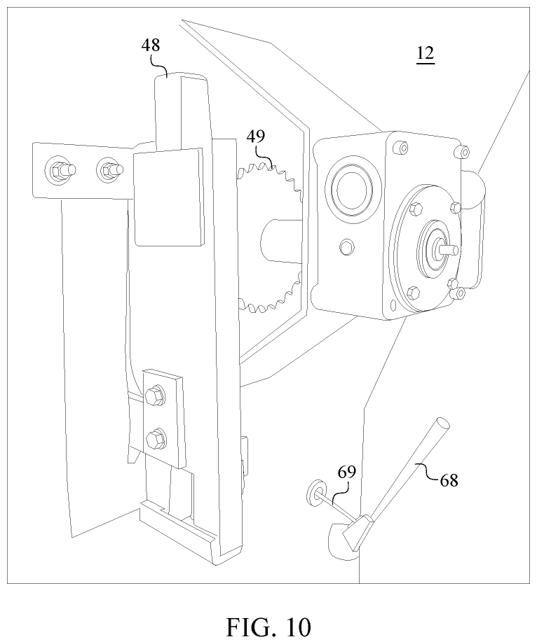

In reference to FIG. 9-10, the clutch system 67 comprises a clutch handle 68, a cable 69, and a spring-loaded actuator 70. The clutch handle 68 is connected to the front wall 11 of the hopper 1 so that the user can switch the clutch system 67 between the engaged position and the disengaged position. The spring-loaded actuator 70 is connected to the main frame 2 and operatively coupled with the spring-loaded ratchet gear 64, wherein the spring-loaded ratchet gear 64 engages and disengages with the main ratchet gear 62 via the operation of the spring-loaded actuator 70. The spring-loaded actuator 70 and the clutch handle 68 are tensionably connected to each other through the cable 69 thus transferring the user input energy of the clutch handle 68 into the spring-loaded actuator 70. For example, when the user applied pressure to the clutch handle 68, the cable 69 transfers the applied pressure to the spring-loaded actuator 70. Then, the spring-loaded actuator 70 pushes the spring-loaded ratchet gear 64 towards the front wall 11 of the hopper 1 thus disengaging the spring-loaded ratchet gear 64 from the main ratchet gear 62. As a result, the present invention is able to halt the operation of the material discharging assembly 4 and the spreader 8 as the first distribution shaft 65 is not able to rotate. When the user releases pressure from the clutch handle 68, the cable 69 transfers the released pressure to the spring-loaded actuator 70 thus returning the spring-loaded actuator 70 to its initial position. Then, the spring-loaded actuator 70 pushes the spring-loaded ratchet gear 64 towards the rear wall 12 of the hopper 1 thus engaging the spring-loaded ratchet gear 64 to the main ratchet gear 62. As a result, the present invention is able to operate the material discharging assembly 4 and the spreader 8 as the first distribution shaft 65 is able to rotate. An integrated compression spring of the spring-loaded ratchet gear 64 enables the spring-loaded actuator 70 to horizontally moves the spring-loaded ratchet gear 64 towards the front wall 11 and the rear wall 12 of the hopper 1.

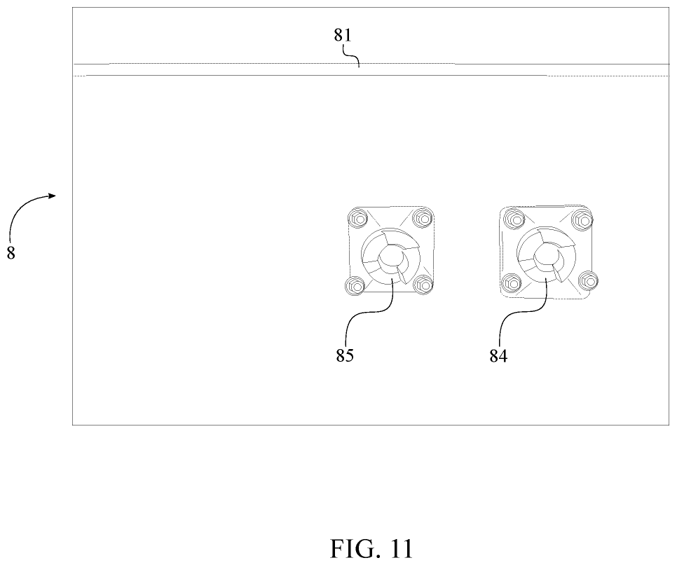

In reference to FIG. 1 and FIG. 11, the spreader 8 comprises a platform 81, a left conveyor belt system 82, a right conveyor belt system 83, a left quick-connect input adaptor 84, and a right quick-connect input adaptor 85. The left conveyor belt system 82 is rotatably mounted to the platform 81. The right conveyor belt system 83 is rotatably mounted to the platform 81. The left conveyor belt system 82 and the right conveyor belt system 83 are oppositely positioned of each other about the platform 81 discharged fertilizer can be outwardly moved away from the splash guard 15 and dropped onto the orchard field through the operation of the left conveyor belt system 82 and the right conveyor belt system 83. The left quick-connect input adaptor 84 is rotatably connected with the left conveyor belt system 82 in order to power the left conveyor belt system 82. The right quick-connect input adaptor 85 is rotatably connected with the right conveyor belt system 83 in order to power the right conveyor belt system 83. When the spreader 8 is mounted to the main frame 2, the left quick-connect input adaptor 84 and the left quick-connect output adaptor 71 are rotatably engaged with each other, and the right quick-connect input adaptor 85 and the right quick-connect output adaptor 72 are rotatably engaged with each other. As a result, the rotational energy of the first distribution shaft 65 is able to power the left conveyor belt system 82 and the right conveyor belt system 83.

In reference to FIG. 2, the present invention further comprises a left spreader mount 22, a right spreader mount 23, a left spring lock 24, and a right spring lock 25. More specifically, the left spreader mount 22 and the left spring lock 24 are connected to the main frame 2 and adjacently positioned to the left sidewall 13 of the hopper 1. The right spreader mount 23 and the right spring lock 25 are connected to the main frame 2 and adjacently positioned to the right sidewall 14 of the hopper 1. The platform 81 is engaged to the main frame 2 through the left spreader mount 22 and the right spreader mount 23 so that the left quick-connect input adaptor 84 and the left quick-connect output adaptor 71 can be concentrically aligned with respect to the left conveyor belt system 82 and the right quick-connect input adaptor 85 and the right quick-connect output adaptor 72 can be concentrically aligned with respect to the right conveyor belt system 83. The platform 81 is removably mounted to the main frame 2 through the left spring lock 24 and the right spring lock 25, wherein the left spring lock 24 and the right spring lock 25 function similar to quick fastening mechanisms within the present invention. Although the invention has been explained in relation to its preferred embodiment, it is to be understood that many other possible modifications and variations can be made without departing from the spirit and scope of the invention as hereinafter claimed.

What is claimed is:

1. A pull behind orchard fertilizing device comprising:
a hopper;
a main frame;
a wheel assembly;
a material discharging assembly;
a gear box;
a spreader;
the hopper being mounted onto the main frame;
the wheel assembly being rotatably mounted to the main frame;
the material discharging assembly being integrated into the hopper;
the gear box being mounted to the main frame;
the spreader being terminally mounted to the main frame;
the hopper being positioned atop the spreader; and
the wheel assembly being operatively coupled with the material discharging assembly and the spreader through the main gear box, wherein stored fertilizer within the hopper is discharged through the operation of the material discharging assembly and the spreader.

2. The pull behind orchard fertilizing device as claimed in claim 1 comprising:
a tractor mount;
the tractor mount being terminally connected to the main frame; and
the tractor mount and the spreader being oppositely positioned of each other about the main frame.

3. The pull behind orchard fertilizing device as claimed in claim 1 comprising:
a splash guard;
the splash guard being terminally connected to a rear wall of the hopper; and
the splash guard being positioned atop the spreader.

4. The pull behind orchard fertilizing device as claimed in claim 1 comprising:
the wheel assembly comprising a straight axle, a left wheel, and a right wheel;
the straight axle being rotatably mounted to the main frame;
the left wheel being terminally mounted to the straight axle;
the left wheel being positioned adjacent to a left sidewall of the hopper;
the right wheel being terminally mounted to the straight axle; and
the right wheel being positioned adjacent to a right sidewall of the hopper.

5. The pull behind orchard fertilizing device as claimed in claim 1 comprising:
the material discharging assembly comprising a main support, a first panel, a second panel, an auger, a gear assembly, and a rear opening;
the main support being internally positioned within the hopper;
the main support being linearly extended from a front wall of the hopper to a rear wall of the hopper;
the first panel being hingedly connected to the main support;
the second panel being hingedly connected to the main support;
the auger being rotatably mounted within the hopper;
the auger being positioned within the first panel and the second panel;
the rear opening traversing through the rear wall of the hopper;
the auger being extended through the rear opening and into a splash guard; and
the main support being operatively coupled with the gear assembly, wherein the gear assembly raises and lowers the main support which simultaneously raises and lowers the first panel and the second panel.

6. The pull behind orchard fertilizing device as claimed in claim 5 comprising:
the gear assembly comprising a front rack gear, a front pinion gear, a rear rack gear, a rear pinion gear, a connector shaft, a tubular body, and a handle;
the tubular body being connected to the front wall of the hopper and the rear wall of the hopper;
the connector shaft being rotatably positioned within the tubular body;
the front rack gear being terminally connected to the main support;
the front pinion gear being rotatably connected to the front wall of the hopper;
the front pinion gear being rotatably engaged with the front rack gear;
the rear rack gear being terminally connected to the main support;
the rear pinion gear being rotatably connected to the rear wall of the hopper;
the rear pinion gear being rotatably engaged with the rear rack gear;
the connector shaft being terminally connected to the front pinion gear and the rear pinion gear; and
the handle being connected onto the front pinion gear.

7. The pull behind orchard fertilizing device as claimed in claim 1 comprising:
the gear box comprising a main shaft, a main ratchet gear, a wheel output shaft, a spring-loaded ratchet gear, a first distribution shaft, a clutch system, a left quick-connect output adaptor, and a right quick-connect output adaptor;
the main shaft and the first distribution shaft being rotatably connected to the main frame;
the main ratchet gear being terminally connected to the main shaft;
the wheel output shaft being rotatably connected to a straight axle of the wheel assembly;
the spring-loaded ratchet gear being terminally connected to the wheel output shaft;
the left quick-connect output adaptor and the right quick-connect output adaptor being rotatably connected to the main frame;
the left quick-connect output adaptor and the right quick-connect output adaptor being operatively coupled with the first distribution shaft, wherein the first distribution shaft rotates the left quick-connect output adaptor and the right quick-connect output adaptor;
the auger being operatively coupled with the first distribution shaft, wherein the first distribution shaft rotates the auger;
the main shaft being operatively coupled with the first distribution shaft, wherein the main shaft rotates the first distribution shaft; and
the main ratchet gear and the spring-loaded ratchet gear being selectively engaged with the clutch system, wherein the clutch system engages and disengages the spring-loaded ratchet gear from the main ratchet gear.

8. The pull behind orchard fertilizing device as claimed in claim 7 comprising:
the clutch system comprising a clutch handle, a cable, and a spring-loaded actuator;
the clutch handle being connected to a front wall of the hopper;
the spring-loaded actuator being connected to the main frame;
the spring-loaded actuator being operatively coupled with the spring-loaded ratchet gear, wherein the spring-loaded ratchet gear engages and disengages with the main ratchet gear via the operation of the spring-loaded actuator; and
the spring-loaded actuator and the clutch handle being tensionably connected to each other through the cable.

9. The pull behind orchard fertilizing device as claimed in claim 1 comprising:
the spreader comprising a platform, a left conveyor belt system, a right conveyor belt system, a left quick-connect input adaptor, and a right quick-connect input adaptor;
the left conveyor belt system being rotatably mounted to the platform;
the right conveyor belt system being rotatably mounted to the platform;
the left conveyor belt system and the right conveyor belt system being oppositely positioned of each other about the platform;
the left quick-connect input adaptor being rotatably connected with the left conveyor belt system; and
the right quick-connect input adaptor being rotatably connected with the right conveyor belt system.

10. The pull behind orchard fertilizing device as claimed in claim 1 comprising:
a left spreader mount;
a right spreader mount;
a left spring lock;
a right spring lock;
the spreader comprising a platform;
the left spreader mount and the left spring lock being connected to the main frame;
the left spreader mount and the left spring lock being adjacently positioned to a left sidewall of the hopper;
the right spreader mount and the right spring lock being connected to the main frame;
the right spreader mount and the right spring lock being adjacently positioned to a right sidewall of the hopper;
the platform being engaged to the main frame through the left spreader mount and the right spreader mount; and
the platform being removably mounted to the main frame through the left spring lock and the right spring lock.

11. The pull behind orchard fertilizing device as claimed in claim 1 comprising:
the spreader comprising a left quick-connect input adaptor and a right quick-connect input adaptor;
the gear box comprising a left quick-connect output adaptor and a right quick-connect output adaptor;
the left quick-connect input adaptor and the left quick-connect output adaptor being rotatably engaged with each other; and
the right quick-connect input adaptor and the right quick-connect output adaptor being rotatably engaged with each other.
